(19) United States
(12) Patent Application Publication
(10) Pub. No.: US 2016/0259703 A1
(43) Pub. Date: Sep. 8, 2016

(54) RETRIEVAL CONTROL METHOD, AND RETRIEVAL CONTROL DEVICE

(71) Applicant: FUJITSU LIMITED, Kawasaki-shi (JP)

(72) Inventors: Junji Kawai, Kakogawa (JP); Sawahiko Sato, Akashi (JP); MASAKI NISHIGAKI, Kobe (JP); Eiji Seki, Akashi (JP)

(73) Assignee: FUJITSU LIMITED, Kawasaki-shi (JP)

(21) Appl. No.: 15/058,304

(22) Filed: Mar. 2, 2016

(30) Foreign Application Priority Data
Mar. 5, 2015 (JP) 2015-043696

(51) Int. Cl. G06F 11/34; G06F 17/30

(52) U.S. Cl. CPC G06F 11/3409; G06F 17/30477; G06F 2201/80

(57) ABSTRACT

A non-transitory computer-readable recording medium stores therein a retrieving control program that causes a computer to execute a process including, receiving a retrieval request including range information; estimating a number of records to be obtained by performing retrieval in a retrieval range; calculating a difference between a cost of retrieval processing time when retrieval processing is performed by a first process or thread which performs the retrieval processing for a record of the total number of records, and the cost of retrieval processing time when retrieval processing is performed by parallel retrieval; calculating a cost of time for giving a record of the estimated number of records from a plurality of processes or threads to the first process or thread; and controlling, according to a comparison result between the difference and the calculated cost of the time, whether the retrieval request is to be processed by the parallel retrieval.

### CROSS-REFERENCE TO RELATED APPLICATION

This application is based upon and claims the benefit of priority of the prior Japanese Patent Application No. 2015-043696, filed on Mar. 5, 2015, the entire contents of which are incorporated herein by reference.

### FIELD

The embodiment discussed herein is related to a retrieval control program, a retrieval control method, and a retrieval control device.

### BACKGROUND

In recent years, performance of central processing units (CPU) has been improved by increasing the number of cores. The CPU having a plurality of cores performs parallel processing for a plurality of processes or threads in the respective cores, thereby accelerating processing speed. For example, data in a database are read by the plurality of processes or threads, thereby accelerating read speed from the database.

In the example of the database, a main process divides, into a plurality of tasks, read for a table to be read. The plurality of processes or threads then executes the respective tasks. The process or thread that processes the divided task is also referred to as a worker. In other words, the number of workers corresponds to the number of cores capable of processing the read for the table. When the number of workers is less than the number of tasks, the worker which has completed the processing for one task is assigned another unexecuted task, whereby all tasks are executed. The main process aggregates execution results of the respective tasks from the respective workers in order to generate a final result.

In addition, use of different degrees of parallelism according to a classification of a retrieval condition in the database has been proposed. Specifically, the retrieval condition included in a query sentence for the database is classified, based on an execution cost upon execution of retrieval, into a low-cost retrieval condition and a high-cost retrieval condition, according to which the different degrees of parallelism are used. The classification according to a cost level is performed for each query sentence.

Patent Literature 1: Japanese Laid-open Patent Publication No. 2013-152512

When parallel processing is performed, however, respective workers simultaneously read information of a table. As a result, a transfer amount of input/output (I/O) between the workers and a storage medium, in which the table is stored, is increased. A memory transfer amount between the respective workers and a main process is also increased. However, it is difficult to readily improve memory transfer speed. In a case where retrieval is performed by the parallel processing, therefore, its performance might fall below performance of normal retrieval, namely retrieval by sequential processing.

### SUMMARY

According to an aspect of an embodiment, a non-transitory computer-readable recording medium stores therein a retrieving control program that causes a computer to execute a process including, receiving a retrieval request including range information that designates a retrieval range of the retrieval request; specifying a total number of records included in the retrieval range designated by the range information, and estimating the number of records to be obtained by performing retrieval in the retrieval range, by utilizing a correspondence relation information stored in a storage unit, the correspondence relation information including relationships between the retrieval range and the total number of records included in the retrieval range; calculating a difference between a cost of retrieval processing time and a cost of retrieval processing time, the cost of retrieval processing time being calculated on a condition when retrieval processing is performed by a first process or thread which performs the retrieval processing for a record of the total number of records, and the cost of retrieval processing time being calculated on a condition when retrieval processing is performed by parallel retrieval using a plurality of processes or threads controlled by the first process or thread; calculating a cost of time for giving a record of the estimated number of records from the plurality of processes or threads to the first process or thread; and controlling, according to a comparison result between the difference and the calculated cost of the time, whether the retrieval request is to be processed by the parallel retrieval.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary configuration of a retrieval control system according to an example.

FIG. 2 is a diagram illustrating an exemplary object database.

FIG. 3 is a diagram illustrating an exemplary catalogue storage unit.

FIG. 4 is a diagram illustrating an exemplary statistical information storage unit.

FIG. 5 is a diagram illustrating exemplary execution images of normal retrieval and parallel retrieval.

FIG. 6 is a diagram illustrating exemplary parallel retrieval.

FIG. 7 is a diagram illustrating exemplary access plans.

FIG. 8 is a diagram describing a cost of the normal retrieval.

FIG. 9 is a diagram describing a cost of the parallel retrieval.

FIG. 10 is a flowchart illustrating exemplary retrieval control processing according to the example.

FIG. 11 is a diagram illustrating an exemplary computer that executes a retrieval control program.

### DESCRIPTION OF EMBODIMENTS

Preferred embodiments of the present invention will be explained with reference to accompanying drawings. The disclosed technique is not limited by the present example. The following example may be appropriately combined in a range without contradiction.

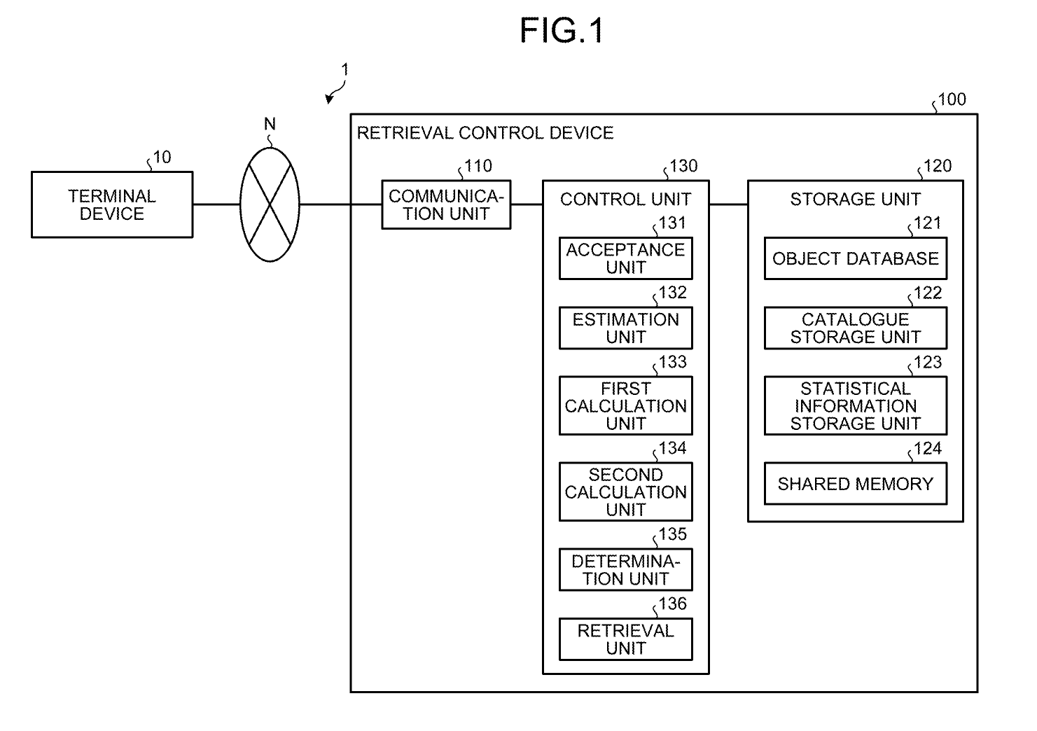

FIG. 1 is a block diagram illustrating an exemplary configuration of a retrieval control system according to an example. A retrieval control system 1 illustrated in FIG. 1 has a terminal device 10 and a retrieval control device 100. Although the system having a single terminal device 10 is illustrated in FIG. 1, the number of terminal devices 10 is not limited, and the retrieval control system 1 may have any number of terminal devices 10.

The terminal device 10 and the retrieval control device 100 are communicably coupled to each other via a network N. Any kind of communication network, whether wired or wireless, may be employed as the network N. Such a communication network includes, in addition to the Internet, a local area network (LAN) and a virtual private network (VPN).

The retrieval control device 100 receives, from the terminal device 10, a retrieval request including information to designate a retrieval range. The retrieval request includes, for example, an SQL sentence. The retrieval control device 100 specifies a total number of records included in the retrieval range designated by the information, by referring to a storage unit, which stores a correspondence relation between the retrieval range and the total number of records included in the retrieval range. The retrieval control device 100 estimates the number of records to be obtained by performing the retrieval in the retrieval range. The retrieval control device 100 calculates a cost of retrieval processing time when retrieval processing is performed by a first process or thread which performs the retrieval processing for a record of the total number of records. The retrieval control device 100 also calculates a cost of retrieval processing time when retrieval processing is performed for the record of the total number of records by parallel retrieval using a plurality of processes or threads controlled by the first process or thread. The retrieval control device 100 calculates a difference between the cost of the retrieval processing time when the retrieval processing is performed by the first process or thread, and the cost of the retrieval processing time when the retrieval processing is performed by the parallel retrieval. The retrieval control device 100 also calculates a cost of time for giving a record of an estimated number of records from the plurality of processes or threads to the first process or thread. The retrieval control device 100 determines, according to a comparison result between the difference and the calculated cost of the time, whether the retrieval request is to be processed by the parallel retrieval. The retrieval control device 100 retrieves, according to a determination result, from a database either by normal retrieval or by the parallel retrieval so as to send a retrieval result to the terminal device 10. As a result, deterioration of performance due to the parallel retrieval can be suppressed.

The terminal device 10 is, for example, a computer used by a user of the database. The terminal device 10 displays and presents, to the user, various types of screens or the like concerning an operation for the database received from the retrieval control device 100. The terminal device 10 may, for example, use a web browser for displaying and operating the various types of screens or the like of the database. The terminal device 10 sends, to the retrieval control device 100, the retrieval request including the information to designate the retrieval range. Such a retrieval request includes, for example, the SQL sentence. The terminal device 10 receives the retrieval result from the retrieval control device 100, and displays the retrieval result on a display unit which is not illustrated in the drawing. A portable personal computer can be employed as an example of the terminal device 10. Not only a portable terminal such as the above-mentioned personal computer, but also a stationary personal computer may be employed as the terminal device 10. A mobile communication terminal may be employed, in addition to the above-mentioned personal computer, as the portable terminal serving as the terminal device 10. The mobile communication terminal includes, for example, a tablet terminal, a smartphone, a cellular phone, and a personal handyphone system (PHS).

Next, a configuration of the retrieval control device 100 will be described. As illustrated in FIG. 1, the retrieval control device 100 has a communication unit 110, a storage unit 120, and a control unit 130. In addition to functional units of the retrieval control device 100 illustrated in FIG. 1, the retrieval control device 100 may have various types of functional units included in known computers. Such functional units include, for example, various types of input devices and audio output devices.

The communication unit 110 is realized by, for example, a network interface card (NIC). The communication unit 110 is a communication interface which is coupled, in a wired or wireless manner, to the terminal device 10 via the network N. The communication unit 110 manages communication of information between the terminal device 10 and the communication unit 110. The communication unit 110 receives the SQL sentence from the terminal device 10. The communication unit 110 outputs the received SQL sentence to the control unit 130. The retrieval result from the database is input from the control unit 130 to the communication unit 110. The communication unit 110 then sends the retrieval result and the various types of screens to the terminal device 10.

The storage unit 120 is realized by, for example, a semiconductor memory device and a storage device. The semiconductor memory device includes, for example, a random access memory (RAM) and a flash memory, and the storage device includes, for example, a hard disc and an optical disk. The storage unit 120 has an object database 121, a catalogue storage unit 122, a statistical information storage unit 123, and a shared memory 124. The storage unit 120 stores information to be used for processing in the control unit 130.

The object database 121 is a relational database that has a plurality of tables for storing various types of information therein. For example, the object database 121 stores customer information in one table, and stores, in other tables, purchased goods and comments or the like.

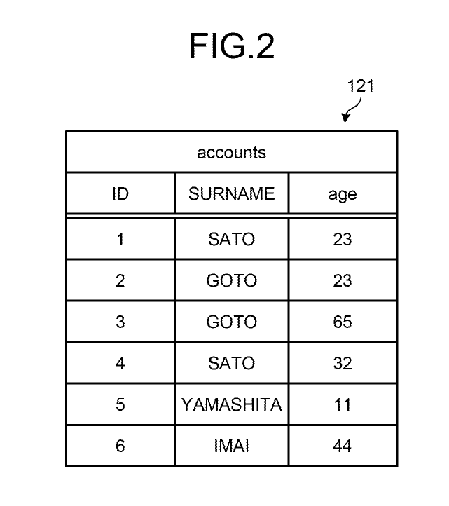

FIG. 2 is a diagram illustrating an exemplary object database. As illustrated in FIG. 2, the object database 121 includes, for example, a table “accounts” in which the customer information is stored. The table “accounts” has items such as “ID”, “surname”, and “age”. For example, the object database 121 stores, in the table in which the customer information is stored, information of a single person as a single record.

The “ID” is an identifier to identify the customer. The “surname” is information to indicate a surname of the customer. The “age” is information to indicate an age of the customer. In the example of FIG. 2, it is illustrated that “Sato” with the ID “1” is “23” years old.

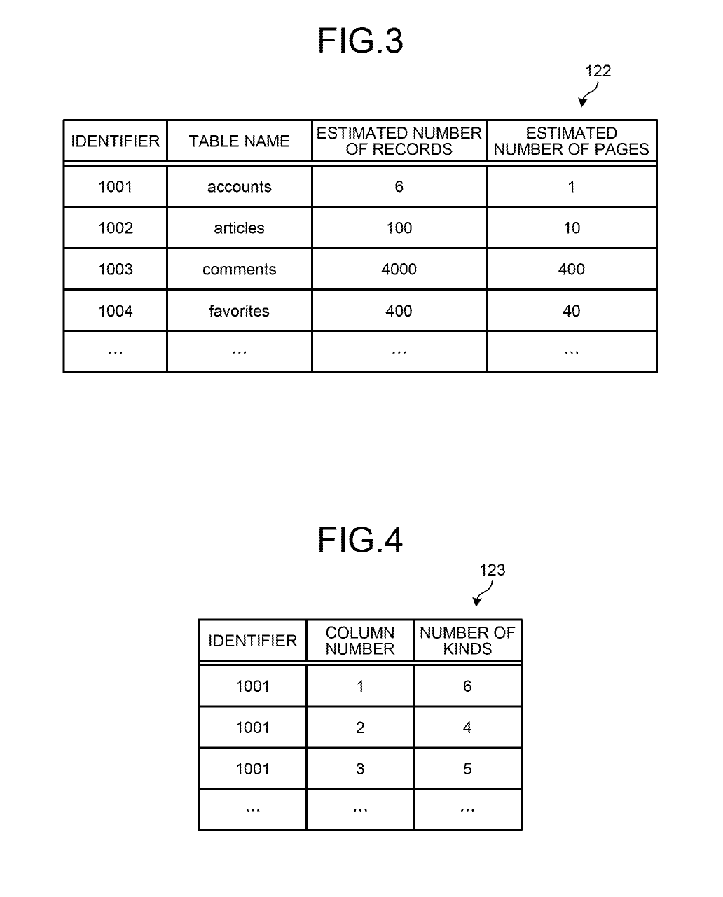

Returning to the description of FIG. 1, the catalogue storage unit 122 stores a table, namely a system catalogue, for managing the table of the object database 121. FIG. 3 is a diagram illustrating an exemplary catalogue storage unit. As illustrated in FIG. 3, the catalogue storage unit 122 has items such as “identifier”, “table name”, “estimated number of records”, and “estimated number of pages”. The catalogue storage unit 122 stores, for example, one record for each table.

The “identifier” is an identifier to identify the table of the object database 121. The “table name” is information to indicate a name of the table of the object database 121. The “estimated number of records” is information to indicate the number of records included in the table. Regarding the estimated number of records, the “estimated” is added to the “number of records” since a last update was performed, for example, five minutes ago, and another record might have been added thereafter. In the following description, the estimated number of records is also referred to as the total number of records included in the retrieval range.

The “estimated number of pages” is information to indicate a region of a storage medium of the table. A page is a region of a storage medium which can be accessed by a worker at a time. A single page may have, for example, 8 kByte. One or more records are stored in the page. Regarding the estimated number of pages, in the same way as the estimated number of records, the “estimated” is added to the “number of pages” since a last update was performed, for example, five minutes ago, and another record might have been added thereafter resulting in an increase in the pages. In the following description, the estimated number of pages is also referred to as a total number of pages in the retrieval range. In the example of a first row of FIG. 3, it is illustrated that “six” records are included in the table “accounts” with the identifier “1001” and stored in the region of “one” page.

Returning to the description of FIG. 1, the statistical information storage unit 123 stores an actual performance of previous retrieval for the object database 121. FIG. 4 is a diagram illustrating an exemplary statistical information storage unit. As illustrated in FIG. 4, the statistical information storage unit 123 has items such as “identifier”, “column number”, and “number of kinds”. The statistical information storage unit 123 stores, for example, one record for each column number. Statistical information stored in the statistical information storage unit 123 is periodically collected by, for example, a statistical information collection process, which is not illustrated in the drawing, executed in the control unit 130.

The “identifier” is the identifier to identify the table of the object database 121. The “column number” is a number to indicate a column of the table of the object database 121. The “number of kinds” is information to indicate the number of kinds of information included in each column of the table of the object database 121. In the example of a second row of FIG. 4, it is illustrated that “four” kinds of surnames are included in the column number “2” of the table with the identifier “1001”.

Returning to the description of FIG. 1, the shared memory 124 is a shared memory for exchanging information between a plurality of workers and a database main process (hereinafter referred to as a DB main process). For example, output from each worker is written in the shared memory 124, and a written content is read by the DB main process. The DB main process is the first process or thread. The plurality of workers is the plurality of processes or threads controlled by the first process or thread.

The control unit 130 is realized by, for example, executing a program by a CPU, a micro processing unit (MPU) or the like in a RAM serving as a working region. The program is stored in an internal storage device. The control unit 130 may also be realized by, for example, an integrated circuit such as an application specific integrated circuit (ASIC) and a field programmable gate array (FPGA). The control unit 130 has an acceptance unit 131, an estimation unit 132, a first calculation unit 133, a second calculation unit 134, a determination unit 135, and a retrieval unit 136. The control unit 130 realizes or executes functions and operations of information processing which will be described below. An internal configuration of the control unit 130 is not limited to the configuration illustrated in FIG. 1. The control unit 130 may be configured differently as long as the information processing, which will be described later, is performed in the configuration.

The acceptance unit 131 receives the retrieval request from the terminal device 10 via the network N and the communication unit 110 so as to accept the retrieval request. In other words, the acceptance unit 131 analyzes an SQL sentence of a query which is the retrieval request. The acceptance unit 131 analyzes the SQL sentence to extract the information to designate the retrieval range. The acceptance unit 131 then outputs, to the estimation unit 132, the information to designate the retrieval range. For example, based on a query “SELECT ID, surname, age from accounts where surname=‘Sato’;”, the acceptance unit 131 outputs, to the estimation unit 132, information to indicate that “the ID, surname, and age of a record with the surname Sato are to be retrieved from the table named accounts”.

When the information to designate the retrieval range is input from the acceptance unit 131, the estimation unit 132 generates access plans based on the information. The estimation unit 132 generates access plans of the normal retrieval and the parallel retrieval. The estimation unit 132 outputs, to the retrieval unit 136, the generated access plans of the normal retrieval and the parallel retrieval.

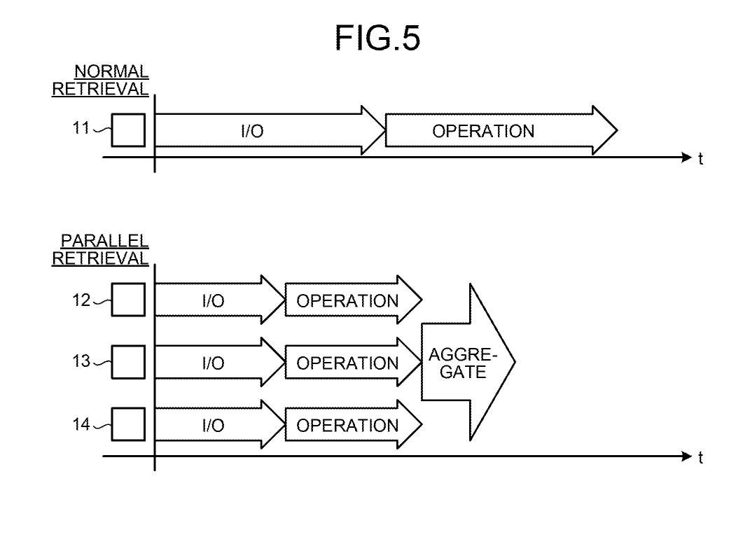

First, the normal retrieval and the parallel retrieval will be described hereinafter. FIG. 5 is a diagram illustrating exemplary execution images of the normal retrieval and the parallel retrieval. As illustrated in FIG. 5, in the normal retrieval, for example, a single DB main process 11 executed in the retrieval unit 136 accesses the table of the object database 121. In FIG. 5, I/O indicates access between the retrieval unit 136 and the object database, and an operation indicates, for example, an operation for the read data. The operation for the read data includes, for example, an operation to add “Mr./Ms.” to the read surname. In the parallel retrieval, for example, three workers 12 to 14 executed in the retrieval unit 136 access different regions of the table of the object database 121. In FIG. 5, an aggregate indicates processing to aggregate output from the workers 12 to 14. Such processing is processed by, for example, the DB main process executed in the retrieval unit 136. Thus, the aggregate processing is overhead. It can be understood from FIG. 5 that the parallel retrieval is effective when time including that for the aggregate processing is shorter than time for the normal retrieval.

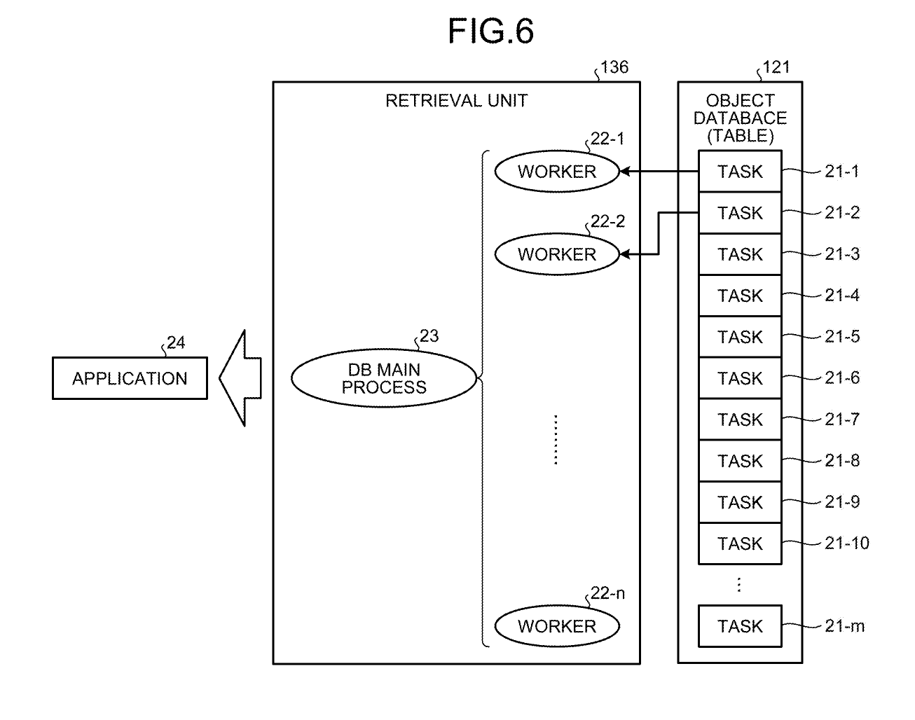

Next, the parallel retrieval will be described in detail using FIG. 6. FIG. 6 is a diagram illustrating exemplary parallel retrieval. The following description will refer to a case where tasks 21-1 to 21-m are provided as processing for accessing the table in the object database 121 as illustrated in FIG. 6. In the following description, when the tasks 21-1 to 21-m are not distinguished from each other, they will be referred to as tasks 21. The retrieval unit 136 is provided with workers 22-1 to 22-n for processing the tasks. In the following description, when the workers 22-1 to 22-n are not distinguished from each other, they will be referred to as workers 22.

In the retrieval unit 136, for example, the worker 22-1 processes the task 21-1 while the worker 22-2 processes the task 21-2. In the retrieval unit 136, in a case where, for example, four workers 22 can process the respective tasks simultaneously, the tasks 21-1 to 21-4 are processed first in the workers 22-1 to 22-4. The tasks 21-5 to 21-m to be processed are then distributed sequentially to the workers 22 which have completed the processing. The retrieval unit 136 is provided with a DB main process 23, which aggregates processing results of the respective workers 22 into a retrieval result. The DB main process then outputs the retrieval result to, for example, an application 24. The application 24 sends the retrieval result to the terminal device 10 via, for example, the communication unit 110 and the network N.

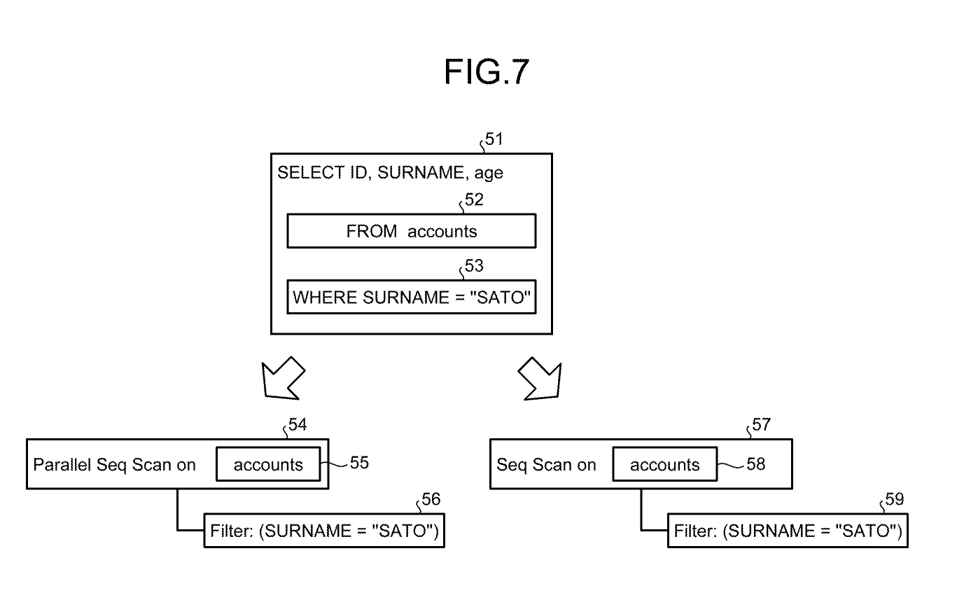

Next, the access plans will be described using FIG. 7. FIG. 7 is a diagram illustrating exemplary access plans. An access plan 54 of the parallel retrieval and an access plan 57 of the normal retrieval, each corresponding to an SQL sentence 51, are illustrated in FIG. 7. The SQL sentence 51 has a sentence to indicate that the “ID, surname, and age” are to be retrieved. The SQL sentence 51 further has a sentence 52 to indicate the table “accounts” to be retrieved, and a sentence 53 to indicate a retrieval condition “surname=‘Sato’”.

The access plan 54 of the parallel retrieval has a sentence 55 corresponding to the sentence 52 to indicate the table to be retrieved. The access plan 54 of the parallel retrieval further has a sentence 56 corresponding to the sentence 53 to indicate an evaluation condition during access, namely the retrieval condition. Similarly, the access plan 57 of the normal retrieval has a sentence 58 corresponding to the sentence 52 to indicate the table to be retrieved. The access plan 57 of the normal retrieval further has a sentence 59 corresponding to the sentence 53 to indicate an evaluation condition during access, namely the retrieval condition. In the example of FIG. 7, a difference between the access plan 54 of the parallel retrieval and the access plan 57 of the normal retrieval is presence/absence of “Parallel”, thereby designating either the parallel retrieval or the normal retrieval.

Returning to the description of the estimation unit 132, the estimation unit 132 specifies, after generating the access plans, the total number of pages in the retrieval range by referring to the catalogue storage unit 122. In other words, the estimation unit 132 refers to the catalogue storage unit 122 to obtain the retrieval range included in the information to designate the retrieval range, namely the estimated number of pages corresponding to the table name to be retrieved. The estimation unit 132 then specifies the estimated number of pages as the total number of pages in the retrieval range. The total number of pages in the retrieval range may be referred to as the total number of records included in the retrieval range, as long as the number of records per page has been determined.

Next, the estimation unit 132 estimates the number of records to be obtained by being retrieved in the retrieval range, namely the number of records returning as the result of the retrieval. The estimation unit 132 refers to the catalogue storage unit 122 to obtain the retrieval range included in the information to designate the retrieval range, namely the estimated number of records corresponding to the table name to be retrieved (total number of records included in the retrieval range). The estimation unit 132 refers to the catalogue storage unit 122 to obtain the identifier of the table name to be retrieved. The estimation unit 132 refers to the statistical information storage unit 123 to obtain the number of kinds corresponding to the obtained identifier and the column number of the item (column) to be retrieved. The estimation unit 132 divides the obtained estimated number of records by the obtained number of kinds to estimate the number of records returning as the result of the retrieval. In the example of FIGS. 2 to 4, the number of records returning as the result of the retrieval for the surname in the table name “accounts” is: estimated number of records “6”/number of kinds “4”=1.5 records. The estimation unit 132 outputs the specified total number of pages in the retrieval range to the first calculation unit 133, and outputs the estimated number of records returning as the result of the retrieval to the second calculation unit 134. In the estimation unit 132, the number of records returning as the result of the retrieval varies according to a change in the retrieval condition. For example, in a case where the age is retrieved instead of the surname, the estimation unit 132 obtains the number of kinds “5” and estimates the number of records returning as the result of the retrieval to be: 6/5=1.2 records.

When the specified total number of pages in the retrieval range is input from the estimation unit 132, the first calculation unit 133 calculates a retrieval cost of the normal retrieval. In other words, the first calculation unit 133 calculates a cost of retrieval by the DB main process for the total number of records included in the retrieval range. Based on the total number of pages in the retrieval range, the first calculation unit 133 calculates the retrieval cost of the normal retrieval by the following formula (1).

Normal retrieval cost=Normal access cost×Number of pages to be accessed (1)

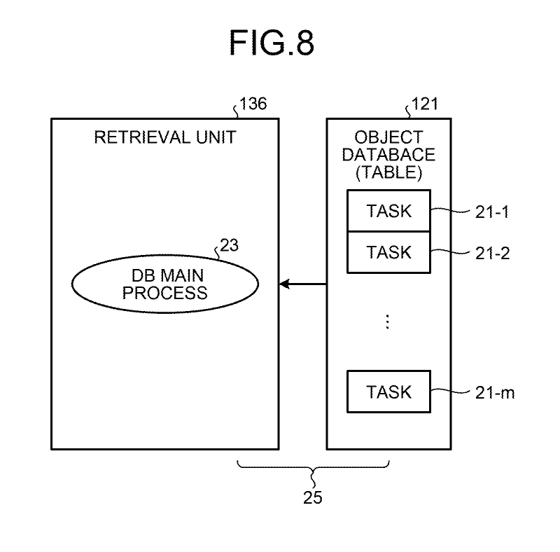

The normal access cost in the above formula (1) can be, for example, a constant “1” as a cost for reading a single page based on the I/O, namely the access to the object database 121. The number of pages to be accessed is the obtained total number of pages in the retrieval range. In the above-mentioned example where the number of pages to be accessed is one page and the surname is retrieved from the table name “accounts”, the normal retrieval cost is: 1×1=1. FIG. 8 is a diagram describing the cost of the normal retrieval. In the normal retrieval, as illustrated in FIG. 8, the DB main process 23 processes each task 21 which is the processing for accessing the table in the object database 121. In this case, a cost for processing the respective tasks 21 by the DB main process 23 is a normal retrieval cost 25 illustrated in the drawing.

Returning to the description of FIG. 1, the first calculation unit 133 calculates a retrieval cost of the parallel retrieval. In other words, the first calculation unit 133 calculates a cost of retrieval by the workers 22 for the total number of pages in the retrieval range. The first calculation unit 133 may calculate the retrieval cost by using the total number of records included in the retrieval range. Based on the total number of pages in the retrieval range, the first calculation unit 133 calculates the retrieval cost of the parallel retrieval by the following formula (2).

Parallel retrieval cost=Parallel access cost×Number of pages to be accessed (2)

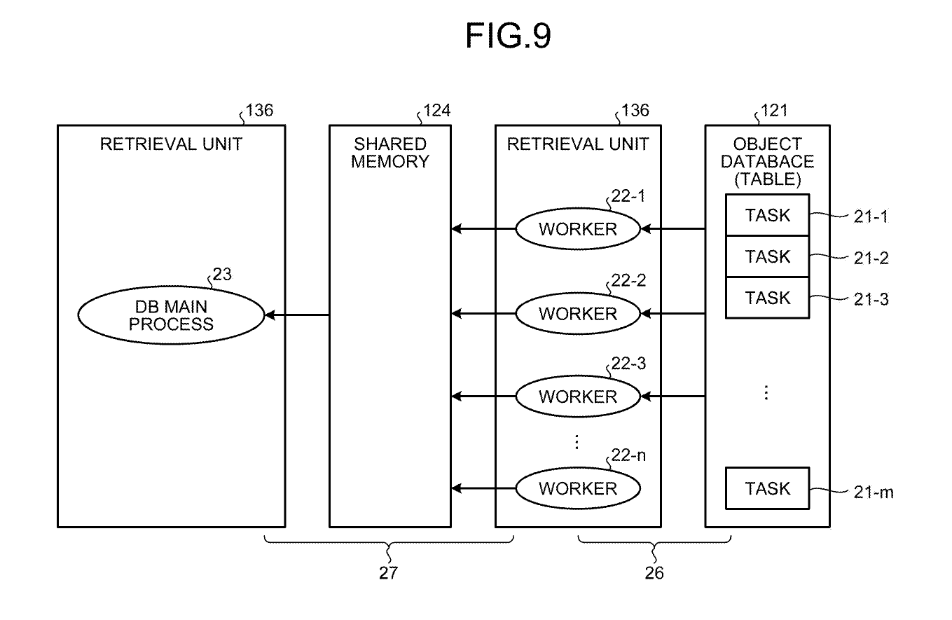

The parallel access cost in the above formula (2) is a constant corresponding to the number of workers 22, and can be, for example, “1/(number of workers 22)”. The number of pages to be accessed is the obtained total number of pages in the retrieval range. In the above-mentioned example where the number of pages to be accessed is one page and the surname is retrieved from the table name “accounts”, assuming that there are four workers 22, the parallel retrieval cost is: 1/4×1=0.25. FIG. 9 is a diagram describing the cost of the parallel retrieval. In the parallel retrieval, as illustrated in FIG. 9, the respective workers 22 process the respective tasks 21 which are the processing for accessing the table in the object database 121. In this case, a cost for processing the respective tasks 21 by the respective workers 22 is a parallel retrieval cost 26 illustrated in the drawing.

After calculating the normal retrieval cost and the parallel retrieval cost, the first calculation unit 133 calculates a difference in the retrieval cost between the normal retrieval and the parallel retrieval. In the above-mentioned example, the difference is: 1−0.25=0.75. The first calculation unit 133 outputs, to the determination unit 135, the calculated difference in the retrieval cost between the normal retrieval and the parallel retrieval.

When the number of records returning as the result of the retrieval is input from the estimation unit 132, the second calculation unit 134 calculates a transfer cost of the parallel retrieval. In other words, the second calculation unit 134 calculates a cost of time for giving a record of the number of records returning as the result of the retrieval from each worker 22 to the DB main process 23. Based on the number of records returning as the result of the retrieval, the second calculation unit 134 calculates the transfer cost of the parallel retrieval by the following formula (3).

Transfer cost=Transfer cost between DB main process and workers×Number of records returning as the result of retrieval (3)

The transfer cost between the DB main process and the workers in the above formula (3) is a cost of time for transferring the obtained record between the DB main process 23 and the workers 22 via the shared memory 124. The transfer cost can be, for example, “0.09”. The transfer cost may be updated according to an actual performance of the transfer between the DB main process 23 and the workers 22. In the above-mentioned example where the number of pages to be accessed is one page and the surname is retrieved from the table name “accounts”, the transfer cost is: 0.09×1.5=0.135. In the example of FIG. 9, a cost for transferring the respective retrieval results from the respective workers 22 to the DB main process 23 via the shared memory 124 is a transfer cost 27 illustrated in the drawing. The second calculation unit 134 outputs the calculated transfer cost to the determination unit 135.

Returning to the description of FIG. 1, when the difference in the retrieval cost between the normal retrieval and the parallel retrieval is input from the first calculation unit 133, and the transfer cost is input from the second calculation unit 134, the determination unit 135 compares the difference with the transfer cost. In other words, the determination unit 135 determines whether the transfer cost is less than the calculated difference in the retrieval cost between the normal retrieval and the parallel retrieval. In the above-mentioned example, since the transfer cost is 0.135 and the difference in the retrieval cost is 0.75, the transfer cost is less than the difference in the retrieval cost.

When the transfer cost is less than the difference in the retrieval cost, the determination unit 135 outputs, to the retrieval unit 136, a retrieval instruction to indicate that the access plan of the parallel retrieval is to be used. When the transfer cost is equal to or greater than the difference in the retrieval cost, the determination unit 135 outputs, to the retrieval unit 136, a retrieval instruction to indicate that the access plan of the normal retrieval is to be used.

The retrieval instruction is input from the determination unit 135 to the retrieval unit 136. The access plans of the normal retrieval and the parallel retrieval are input from the estimation unit 132 to the retrieval unit 136. When the retrieval instruction is the retrieval instruction to indicate that the access plan of the parallel retrieval is to be used, the retrieval unit 136 retrieves from the object database 121 by using the access plan of the parallel retrieval. The retrieval unit 136 then sends the retrieval result to the terminal device 10 via the communication unit 110 and the network N. When the retrieval instruction is the retrieval instruction to indicate that the access plan of the normal retrieval is to be used, the retrieval unit 136 retrieves from the object database 121 by using the access plan of the normal retrieval. The retrieval unit 136 then sends the retrieval result to the terminal device 10 via the communication unit 110 and the network N. In the retrieval unit 136, an amount of pages to be read upon the retrieval varies according to the table name included in the access plan.

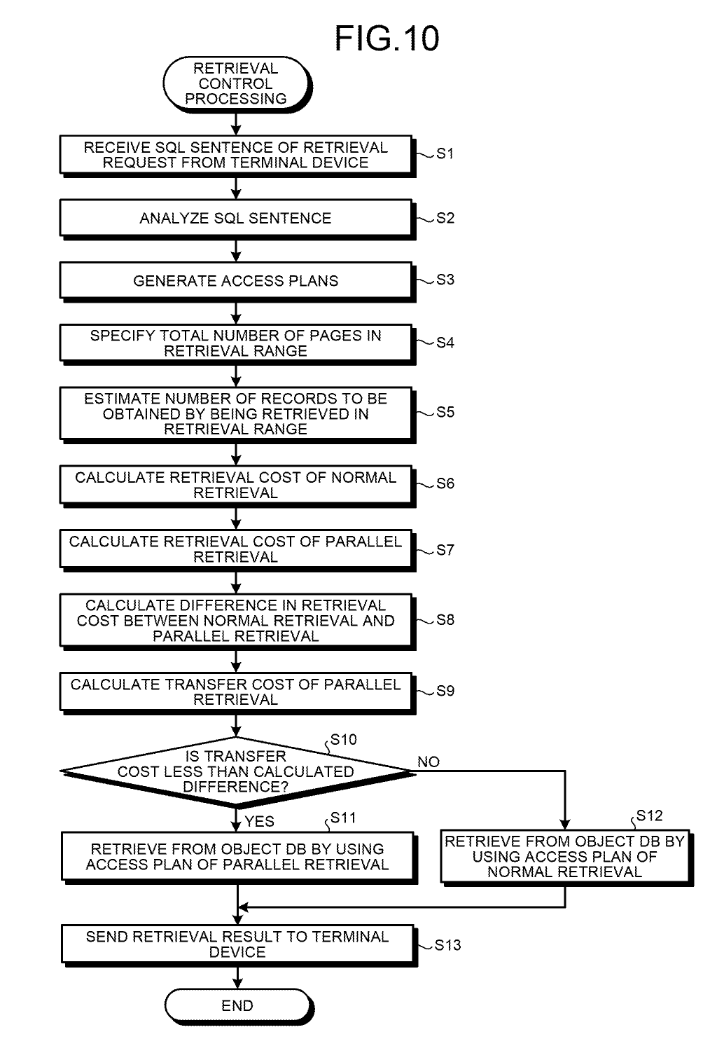

Next, an operation of the retrieval control device 100 according to the example will be described. FIG. 10 is a flowchart illustrating exemplary retrieval control processing according to the example.

The acceptance unit 131 receives the SQL sentence of the retrieval request from the terminal device 10 via the network N and the communication unit 110 (step S1). The acceptance unit 131 analyzes the received SQL sentence to extract the information to designate the retrieval range, and outputs the information to designate the retrieval range to the estimation unit 132 (step S2). When the information to designate the retrieval range is input from the acceptance unit 131, the estimation unit 132 generates the access plans of the normal retrieval and the parallel retrieval based on the information (step S3). The estimation unit 132 outputs, to the retrieval unit 136, the generated access plans of the normal retrieval and the parallel retrieval.

The estimation unit 132 specifies, after generating the access plans, the total number of pages in the retrieval range by referring to the catalogue storage unit 122 (step S4). The estimation unit 132 estimates the number of records to be obtained by being retrieved in the retrieval range, namely the number of records returning as the result of the retrieval (step S5). The estimation unit 132 outputs the specified total number of pages in the retrieval range to the first calculation unit 133, and outputs the estimated number of records returning as the result of the retrieval to the second calculation unit 134.

When the specified total number of pages in the retrieval range is input from the estimation unit 132, the first calculation unit 133 calculates the retrieval cost of the normal retrieval (step S6). The first calculation unit 133 also calculates the retrieval cost of the parallel retrieval (step S7). After calculating the normal retrieval cost and the parallel retrieval cost, the first calculation unit 133 calculates the difference in the retrieval cost between the normal retrieval and the parallel retrieval (step S8). The first calculation unit 133 outputs, to the determination unit 135, the calculated difference in the retrieval cost between the normal retrieval and the parallel retrieval.

When the number of records returning as the result of the retrieval is input from the estimation unit 132, the second calculation unit 134 calculates the transfer cost of the parallel retrieval (step S9). The second calculation unit 134 outputs the calculated transfer cost to the determination unit 135. The difference in the retrieval cost between the normal retrieval and the parallel retrieval is input from the first calculation unit 133 to the determination unit 135. The transfer cost is input from the second calculation unit 134 to the determination unit 135. The determination unit 135 determines whether the transfer cost is less than the calculated difference in the retrieval cost between the normal retrieval and the parallel retrieval (step S10).

When the transfer cost is less than the difference in the retrieval cost (step S10: Yes), the determination unit 135 outputs, to the retrieval unit 136, the retrieval instruction to indicate that the access plan of the parallel retrieval is to be used. The retrieval instruction is input from the determination unit 135 to the retrieval unit 136. The access plans of the normal retrieval and the parallel retrieval are input from the estimation unit 132 to the retrieval unit 136. Since the retrieval instruction is the retrieval instruction to indicate that the access plan of the parallel retrieval is to be used, the retrieval unit 136 retrieves from the object database 121 by using the access plan of the parallel retrieval (step S11). The retrieval unit 136 then sends the retrieval result to the terminal device 10 (step S13).

When the transfer cost is equal to or greater than the difference in the retrieval cost (step S10: No), the determination unit 135 outputs, to the retrieval unit 136, the retrieval instruction to indicate that the access plan of the normal retrieval is to be used. The retrieval instruction is input from the determination unit 135 to the retrieval unit 136. The access plans of the normal retrieval and the parallel retrieval are input from the estimation unit 132 to the retrieval unit 136. Since the retrieval instruction is the retrieval instruction to indicate that the access plan of the normal retrieval is to be used, the retrieval unit 136 retrieves from the object database 121 by using the access plan of the normal retrieval (step S12). The retrieval unit 136 then sends the retrieval result to the terminal device 10 (step S13). Thus, the retrieval control device 100 performs the parallel retrieval when the transfer cost of the parallel retrieval is less than the difference in the retrieval cost between the normal retrieval and the parallel retrieval, and performs the normal retrieval when the transfer cost is equal to or greater than the difference in the retrieval cost. As a result, the deterioration of the performance due to the parallel retrieval can be suppressed. In other words, in a case where both the parallel retrieval and the normal retrieval can be used for accessing the object database 121, the retrieval control device 100 can access the object database 121 by using a retrieval method with faster execution speed.

As described above, the retrieval control device 100 receives the retrieval request including the information to designate the retrieval range. The retrieval control device 100 specifies the total number of records included in the retrieval range designated by the information, by referring to the storage unit 120, which stores the correspondence relation between the retrieval range and the total number of records included in the retrieval range. The retrieval control device 100 estimates the number of records to be obtained by performing the retrieval in the retrieval range. The retrieval control device 100 calculates the difference between the cost of the retrieval processing time when the retrieval processing is performed by the first process or thread that performs the retrieval processing for the record of the total number of records, and the cost of the retrieval processing time when the retrieval processing is performed by the parallel retrieval using the plurality of processes or threads controlled by the first process or thread. The retrieval control device 100 also calculates the cost of the time for giving the record of the estimated number of records from the plurality of processes or threads to the first process or thread. The retrieval control device 100 controls, according to the comparison result between the difference and the calculated cost of the time, whether the retrieval request is to be processed by the parallel retrieval. As a result, the deterioration of the performance due to the parallel retrieval can be suppressed.

The retrieval control device 100 calculates the cost of the retrieval processing time when the retrieval processing is performed by the parallel retrieval, based on a cost calculated by multiplying the transfer cost between the first process or thread and the plurality of processes or threads by the estimated number of records, and based on a cost calculated by multiplying the access cost of each process or each thread in the plurality of processes or threads by the total number of records. As a result, the cost of the parallel retrieval can be calculated according to a content to be retrieved.

The retrieval control device 100 updates, among the cost of the retrieval processing time when the retrieval processing is performed by the parallel retrieval, the transfer cost between the first process or thread and the plurality of processes or threads according to an actual performance of the retrieval processing, so as to calculate the difference based on the updated transfer cost. As a result, calculation accuracy for the cost of the parallel retrieval can be improved.

The retrieval control device 100 estimates the number of records using a kind of an item included in a record to be retrieved. As a result, the cost of the parallel retrieval can be calculated according to the kind of the item.

In the above-mentioned example, the estimated number of records in the catalogue storage unit 122 is six records per page of the estimated number of pages. However, the estimated number of records is not limited to this example. For example, some pages in the estimated number of pages may have six records, and the others may have seven records.

Illustrated components of the respective units are not necessarily physically configured as illustrated in the drawings. In other words, specific forms of separation and integration of the respective units are not limited to the examples illustrated in the drawings. All or a part thereof can be functionally or physically separated or integrated in any unit according to various types of loads and usage. For example, the first calculation unit 133 and the second calculation unit 134 may be integrated.

In addition, various types of processing functions performed in the respective devices may be configured such that all or any part thereof are executed on the CPU (or a microcomputer such as the MPU and a micro controller unit (MCU)). Needless to say, the various types of processing functions may be configured such that all or any part thereof are executed on a program which is analyzed and executed in the CPU (or the microcomputer such as the MPU and the MCU), or on hardware by wired logic.

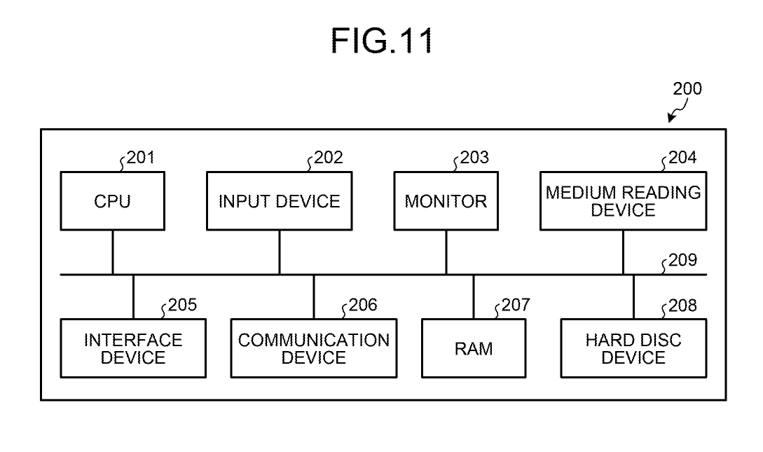

Meanwhile, the various types of processing described in the above-mentioned example can be realized by executing a program, prepared in advance, by the computer. Hereinafter, therefore, an exemplary computer that executes a program having functions similar to those of the above-mentioned example will be described. FIG. 11 is a diagram illustrating an exemplary computer that executes a retrieval control program.

As illustrated in FIG. 11, a computer 200 has a CPU 201, an input device 202, and a monitor 203. The CPU 201 executes various types of operation processing. The input device 202 accepts data input. The computer 200 also has a medium reading device 204, an interface device 205, and a communication device 206. The medium reading device 204 reads a program or the like from a storage medium. The interface device 205 is coupled to various types of devices. The communication device 206 is coupled, in a wired or wireless manner, to another information processing device or the like. The computer 200 further has a RAM 207 and a hard disc device 208. The RAM 207 temporarily stores various types of information. Each of the devices 201 to 208 is connected to a bus 209.

A retrieval control program is stored in the hard disc device 208. The retrieval control program has functions similar to those of the respective processing units illustrated in FIG. 1, namely the acceptance unit 131, the estimation unit 132, the first calculation unit 133, the second calculation unit 134, the determination unit 135, and the retrieval unit 136. The object database 121, the catalogue storage unit 122, the statistical information storage unit 123, the shared memory 124, and various types of data for realizing the retrieval control program are also stored in the hard disc device 208. The input device 202 accepts, from an administrator of the computer 200, for example, input of the various types of information such as management information. The monitor 203 displays, to the administrator of the computer 200, for example, various types of screens such as a screen of the management information. The interface device 205 is coupled to, for example, a printing device or the like. The communication device 206 has, for example, a function similar to that of the communication unit 110 illustrated in FIG. 1. The communication device 206 is connected to the network N to exchange, with the terminal device 10, the query and the various types of information.

The CPU 201 reads each program stored in the hard disc device 208. The CPU 201 then develops and executes the program in the RAM 207, thereby performing the various types of processing. These programs can cause the computer 200 to function as the acceptance unit 131, the estimation unit 132, the first calculation unit 133, the second calculation unit 134, the determination unit 135, and the retrieval unit 136 illustrated in FIG. 1.

The above-mentioned retrieval control program is not necessarily stored in the hard disc device 208. For example, a program stored in a storage medium readable by the computer 200 may be read and executed by the computer 200. The storage medium readable by the computer 200 corresponds to, for example, a portable recording medium, a semiconductor memory, and a hard disc drive. The portable recording medium includes, for example, a CD-ROM, a DVD disk, and a universal serial bus (USB) memory. The semiconductor memory includes, for example, a flash memory. In addition, the retrieval control program may be stored in a device connected to, for example, a public line, the Internet, and the LAN. The retrieval control program then may be read from the device and executed by the computer 200.

Deterioration of performance due to parallel retrieval can be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a retrieving control program that causes a computer to execute a process comprising:
receiving a retrieval request including range information that designates a retrieval range of the retrieval request;
specifying a total number of records included in the retrieval range designated by the range information, and estimating the number of records to be obtained by performing retrieval in the retrieval range, by utilizing a correspondence relation information stored in a storage unit, the correspondence relation information including relationships between the retrieval range and the total number of records included in the retrieval range;
calculating a difference between a cost of retrieval processing time and a cost of retrieval processing time, the cost of retrieval processing time being calculated on a condition when retrieval processing is performed by a first process or thread which performs the retrieval processing for a record of the total number of records, and the cost of retrieval processing time being calculated on a condition when retrieval processing is performed by parallel retrieval using a plurality of processes or threads controlled by the first process or thread;
calculating a cost of time for giving a record of the estimated number of records from the plurality of processes or threads to the first process or thread; and
controlling, according to a comparison result between the difference and the calculated cost of the time, whether the retrieval request is to be processed by the parallel retrieval.

2. The non-transitory computer-readable recording medium according to claim 1, wherein
the processing of calculating the difference calculates the cost of the retrieval processing time when the retrieval processing is performed by the parallel retrieval, based on a cost calculated by multiplying a transfer cost between the first process or thread and the plurality of processes or threads by the estimated number of records, and based on a cost calculated by multiplying an access cost of each process or each thread in the plurality of processes or threads by the total number of records.

3. The non-transitory computer-readable recording medium according to claim 2, wherein
the processing of calculating the difference updates, among the cost of the retrieval processing time when the retrieval processing is performed by the parallel retrieval, the transfer cost between the first process or thread and the plurality of processes or threads according to an actual performance of the retrieval processing, so as to calculate the difference based on the updated transfer cost.

4. The non-transitory computer-readable recording medium according to claim 1, wherein
the processing of estimating estimates the number of records using a kind of an item included in a record to be retrieved.

5. A retrieval control method by a computer, comprising:
receiving a retrieval request including range information that designates a retrieval range of the retrieval request;
specifying a total number of records included in the retrieval range designated by the range information, and estimating the number of records to be obtained by performing retrieval in the retrieval range, by utilizing a correspondence relation information stored in a storage unit, the correspondence relation information including relationships between the retrieval range and the total number of records included in the retrieval range;
calculating a difference between a cost of retrieval processing time and a cost of retrieval processing time, the cost of retrieval processing time being calculated on a condition when retrieval processing is performed by a first process or thread which performs the retrieval processing for a record of the total number of records, and the cost of retrieval processing time being calculated on a condition when retrieval processing is performed by parallel retrieval using a plurality of processes or threads controlled by the first process or thread;
calculating a cost of time for giving a record of the estimated number of records from the plurality of processes or threads to the first process or thread; and
controlling, according to a comparison result between the difference and the calculated cost of the time, whether the retrieval request is to be processed by the parallel retrieval.

6. The retrieval control method according to claim 5, wherein
the processing of calculating the difference calculates the cost of the retrieval processing time when the retrieval processing is performed by the parallel retrieval, based on a cost calculated by multiplying a transfer cost between the first process or thread and the plurality of processes or threads by the estimated number of records, and based on a cost calculated by multiplying an access cost of each process or each thread in the plurality of processes or threads by the total number of records.

7. The retrieval control method according to claim 6, wherein
the processing of calculating the difference updates, among the cost of the retrieval processing time when the retrieval processing is performed by the parallel retrieval, the transfer cost between the first process or thread and the plurality of processes or threads according to an actual performance of the retrieval processing, so as to calculate the difference based on the updated transfer cost.

8. The retrieval control method according to claim 5, wherein
the processing of estimating estimates the number of records using a kind of an item included in a record to be retrieved.

9. A retrieval control device comprising:
a communication unit configured to receive a retrieval request including range information that designates a retrieval range of the retrieval request;
an estimation unit configured to specify a total number of records included in the retrieval range designated by the range information, and to estimate the number of records to be obtained by performing retrieval in the retrieval range, by utilizing a correspondence relation information stored in a storage unit, the correspondence relation information including relationships between the retrieval range and the total number of records included in the retrieval range;
a first calculation unit configured to calculate a difference between a cost of retrieval processing time and a cost of retrieval processing time, the cost of retrieval processing time being calculated on a condition when retrieval processing is performed by a first process or thread which performs the retrieval processing for a record of the total number of records, and the cost of retrieval processing time being calculated on a condition when retrieval processing is performed by parallel retrieval using a plurality of processes or threads controlled by the first process or thread;
a second calculation unit configured to calculate a cost of time for giving a record of the estimated number of records from the plurality of processes or threads to the first process or thread; and
a determination unit configured to control, according to a comparison result between the difference and the calculated cost of the time, whether the retrieval request is to be processed by the parallel retrieval.

10. The retrieval control device according to claim 9, wherein
the first calculation unit calculates the cost of the retrieval processing time when the retrieval processing is performed by the parallel retrieval, based on a cost calculated by multiplying a transfer cost between the first process or thread and the plurality of processes or threads by the estimated number of records, and based on a cost calculated by multiplying an access cost of each process or each thread in the plurality of processes or threads by the total number of records.

11. The retrieval control device according to claim 10, wherein
the first calculation unit updates, among the cost of the retrieval processing time when the retrieval processing is performed by the parallel retrieval, the transfer cost between the first process or thread and the plurality of processes or threads according to an actual performance of the retrieval processing, so as to calculate the difference based on the updated transfer cost.

12. The retrieval control device according to claim 9, wherein
the estimation unit estimates the number of records using a kind of an item included in a record to be retrieved.
